(19) United States
(12) Patent Application Publication
(10) Pub. No.: US 2025/0321908 A1
(43) Pub. Date: Oct. 16, 2025

(54) Network apparatus and operation method thereof having slave circuit broadcast accessing mechanism

(71) Applicant: REALTEK SEMICONDUCTOR CORPORATION, HSINCHU (TW)

(72) Inventors: PEN-AO CHEN, Hsinchu (TW); I-HSUEH LIN, Hsinchu (TW); KUO-CHOU CHENG, Hsinchu (TW); CHE-LUN KUO, Hsinchu (TW)

(21) Appl. No.: 19/097,909

(22) Filed: Apr. 2, 2025

(30) Foreign Application Priority Data
Apr. 10, 2024 (TW) 113113445

(51) Int. Cl. G06F 13/20; G06F 13/42

(52) U.S. Cl. CPC G06F 13/20; G06F 13/4282

(57) ABSTRACT

The present invention discloses a network apparatus having slave circuit broadcast accessing mechanism. Each of lower layer slave circuits has an independent device address. An upper layer master circuit transmits a broadcast mode activation command including a broadcast address to lower layer slave circuits to configure the lower layer slave circuits with the broadcast address to enter a broadcast mode, transmit a broadcast mode write command including the broadcast address and broadcast write data to the lower layer slave circuits such that the lower layer slave circuits configured to have the broadcast address perform data writing according to the broadcast write data and transmit a broadcast mode read command including the broadcast address to the lower layer slave circuits to request one of the lower layer slave circuits having a device address being the same as the broadcast address to perform data reading and return individual read data.

### BACKGROUND OF THE INVENTION

### 1. Field of the Invention

The present invention relates to a network apparatus and a network apparatus operation method thereof having slave circuit broadcast accessing mechanism.

### 2. Description of Related Art

In a network apparatus, a physical layer (PHY) circuit is used to connect a data link layer device of a media access control circuit to a physical media such as an optical fiber or a copper cable. As a result, a physical layer circuit operates as a communication port connecting the network.

In the network apparatus, the media access control circuit serving as a master can be connected to a plurality of physical layer circuits serving as slaves in practical implementation to perform communication through the network. However, in some usage scenarios, the media access control circuit needs to perform data writing or data reading simultaneously on a plurality of physical layer circuits. In a proper communication mechanism is absent, data transmission conflicts occur when the data writing or the data reading is performed simultaneously such that an error of the data transmission occurs.

### SUMMARY OF THE INVENTION

In consideration of the problem of the prior art, an object of the present invention is to supply a network apparatus and a network apparatus operation method thereof having slave circuit broadcast accessing mechanism.

The present invention discloses a network apparatus having a slave circuit broadcast accessing mechanism that includes a plurality of lower layer slave circuits and an upper layer master circuit. Each of the lower layer slave circuits each has a device address independent from each other. The upper layer master circuit is electrically coupled to the lower layer slave circuits to perform network communication through the lower layer slave circuits. The upper layer master circuit configured to transmit a broadcast mode activation command including a broadcast address to the lower layer slave circuits to configure each of the lower layer slave circuits to have the broadcast address such that the lower layer slave circuits enter a broadcast mode, transmit a broadcast mode write command including the broadcast address and broadcast write data to the lower layer slave circuits such that the lower layer slave circuits configured to have the broadcast address perform data writing according to the broadcast write data and transmit a broadcast mode read command including the broadcast address to the lower layer slave circuits such that only one of the lower layer slave circuits having the device address matching the broadcast address performs data reading and returns individual read data.

The present invention also discloses a network apparatus operation method having a slave circuit broadcast accessing mechanism that includes steps outlined below. A broadcast mode activation command including a broadcast address is transmitted to a plurality of lower layer slave circuits by an upper layer master circuit electrically coupled to the lower layer slave circuits, to configure each of the lower layer slave circuits to have the broadcast address such that the lower layer slave circuits enter a broadcast mode, wherein the lower layer slave circuits each has a device address independent from each other. A broadcast mode write command including the broadcast address and broadcast write data is transmitted by the upper layer master circuit to the lower layer slave circuits such that the lower layer slave circuits configured to have the broadcast address perform data writing according to the broadcast write data. A broadcast mode read command including the broadcast address is transmitted by the upper layer master circuit to the lower layer slave circuits such that only one of the lower layer slave circuits having the device address matching the broadcast address performs data reading and returns individual read data.

These and other objectives of the present invention will no doubt become obvious to those of ordinary skill in the art behind reading the following detailed description of the preferred embodiments that are illustrated in the various figures and drawings.

### BRIEF DESCRIPTION OF THE DRAWINGS

FIG. 1 illustrates a block diagram of a network apparatus having a slave circuit broadcast accessing mechanism according to an embodiment of the present invention

FIG. 2A to FIG. 2C are block diagrams of the network apparatus under the condition that the lower layer slave circuits operate in the broadcast mode according to an embodiment of the present invention.

FIG. 3A to FIG. 3C are block diagrams of the network apparatus under the condition that the lower layer slave circuits operate in the non-broadcast mode according to an embodiment of the present invention.

FIG. 4 illustrates a flow chart of a network apparatus operation method having a slave circuit broadcast accessing mechanism according to an embodiment of the present invention.

### DETAILED DESCRIPTION OF THE PREFERRED EMBODIMENTS

An aspect of the present invention is to provide a network apparatus and a network apparatus operation method thereof having slave circuit broadcast accessing mechanism to configure each of lower layer slave circuits to have a broadcast address and perform data writing on the lower layer slave circuits simultaneously according to a broadcast mode write command and requests only one of the lower layer slave circuits having the device address matching the broadcast address performing data reading according to a broadcast mode read command to avoid the false data reading result occurs due to the simultaneously reading.

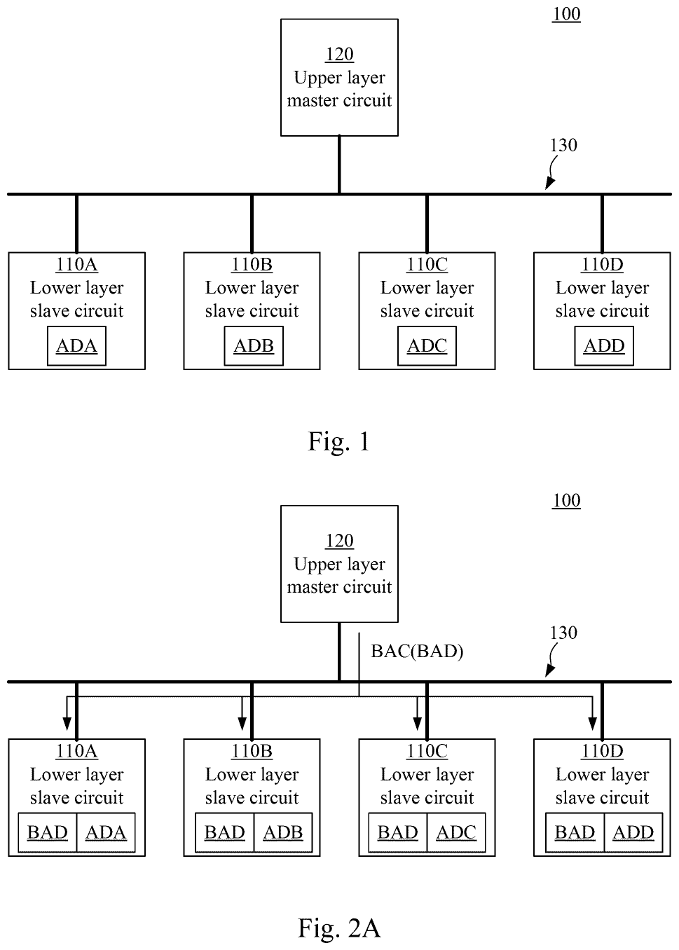

Reference is now made to FIG. 1. FIG. 1 illustrates a block diagram of a network apparatus 100 having a slave circuit broadcast accessing mechanism according to an embodiment of the present invention. The network apparatus 100 includes a plurality of lower layer slave circuits 110A˜110D and an upper layer master circuit 120.

In an embodiment, each of the lower layer slave circuits 110A˜110D is a physical layer (PHY) circuit and the upper layer master circuit 120 is a media access control circuit. Each of the lower layer slave circuits 110A˜110D operates as a communication port connected to a network. The upper layer master circuit 120 is electrically coupled to the lower layer slave circuits 110A˜110D through such as, but not limited to a bus 130, to perform network communication with the lower layer slave circuits 110A˜110D.

In an embodiment, the bus 130 between the upper layer master circuit 120 and the lower layer slave circuits 110A˜110D is a serial management interface (SMI), also known as a management data input/output interface (MDIO). As a result, the lower layer slave circuits 110A˜110D and the upper layer master circuit 120 perform communication through such a serial management interface such that each of the lower layer slave circuits 110A˜110D serves as a serial management interface slave, and the upper layer master circuit 120 serves as a serial management interface master.

Each of the lower layer slave circuits 110A˜110D has one of the device addresses ADA˜ADD independent from each other. In an embodiment, each of the device addresses ADA˜ADD that each of the lower layer slave circuits 110A˜110D has is a sum of a base address and a device identification number. In an embodiment, since each of the lower layer slave circuits 110A˜110D operates as a communication port, the device identification number is a communication port identification number.

For example, the base address is configured to be 0, and the device identification numbers of the lower layer slave circuits 110A˜110D are 0, 1, 2 and 3. The device addresses ADA˜ADD that the lower layer slave circuits 110A˜110D have are 0, 1, 2, 3, each is a sum of the base address and the corresponding one of the device identification numbers.

It is appreciated that the configuration of the device address described above is merely an example. The present invention is not limited to a specific device address configuration.

The upper layer master circuit 120 controls the lower layer slave circuits 110A˜110D to operate in one of a broadcast mode and a non-broadcast mode.

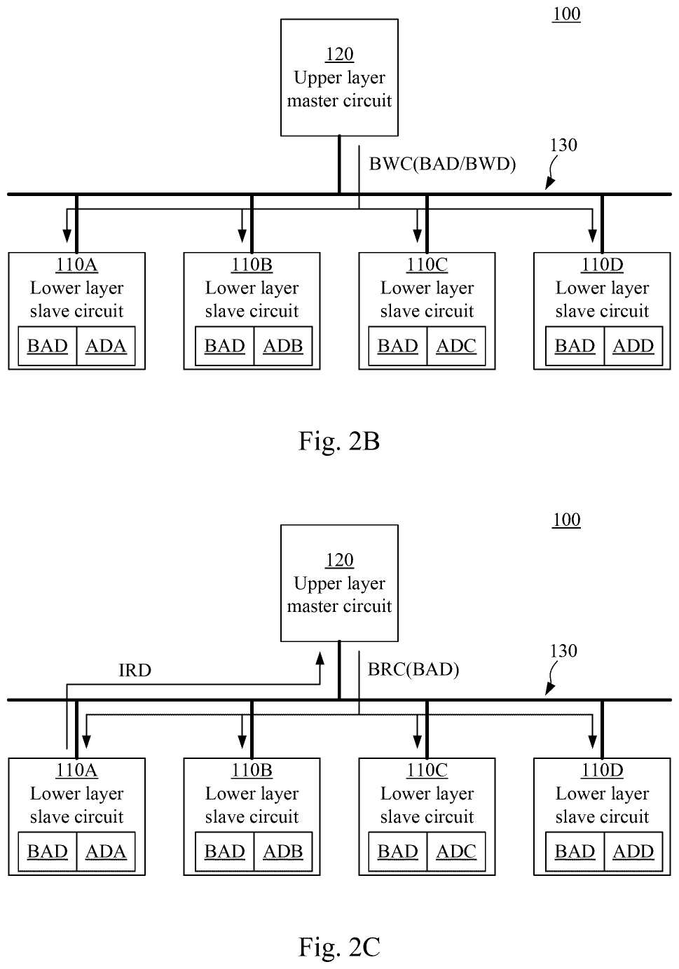

The operation of the lower layer slave circuits 110A˜110D in the broadcast mode is described in the following paragraphs in accompany with FIG. 2A to FIG. 2C.

FIG. 2A to FIG. 2C are block diagrams of the network apparatus 100 under the condition that the lower layer slave circuits 110A˜110D operate in the broadcast mode according to an embodiment of the present invention.

As illustrated in FIG. 2A, the upper layer master circuit 120 is configured to transmit a broadcast mode activation command BAC including a broadcast address BAD to the lower layer slave circuits 110A˜110D to configure each of the lower layer slave circuits 110A˜110D to have the broadcast address BAD and enter the broadcast mode.

In an embodiment, when the network apparatus 100 begins to operate, the lower layer slave circuits 110A˜110D is default to operation in the non-broadcast mode. In order to simultaneously write the configuration data to the lower layer slave circuits 110A˜110D, the upper layer master circuit 120 transmits the broadcast mode activation command BAC to control the lower layer slave circuits 110A˜110D to enter the broadcast mode.

The broadcast address BAD is configured to be the device address of one of the lower layer slave circuits 110A˜110D. For example, the broadcast address BAD can be configured to be the device address ADA of the lower layer slave circuit 110A, i.e., 0. In other embodiments, the broadcast address BAD can also be configured to be the device address of one of the other lower layer slave circuits. The present invention is not limited thereto.

The broadcast mode activation command BAC configure the lower layer slave circuits 110A˜110D that receive the broadcast mode activation command BAC to have the broadcast address BAD. In an embodiment, the configuration of the broadcast address BAD is to control the lower layer slave circuits 110A˜110D to store the broadcast address BAD in an internal storage circuit (not illustrated) such that the lower layer slave circuits 110A˜110D that enters the broadcast mode operate according to the stored broadcast address BAD.

As illustrated in FIG. 2B, when the lower layer slave circuits 110A˜110D enter the broadcast mode, the upper layer master circuit 120 is configured to transmit a broadcast mode write command BWC that includes the broadcast address BAD and a broadcast write data BWD to the lower layer slave circuits 110A˜110D, such that the lower layer slave circuits 110A˜110D configured to have the broadcast address BAD perform data writing according to the broadcast write data BWD.

More specifically, since the lower layer slave circuits 110A˜110D are configured to have the broadcast address BAD according to the broadcast mode activation command BAC, the lower layer slave circuits 110A˜110D determines that the broadcast address BAD included by the broadcast mode write command BWC matches the broadcast address BAD that the lower layer slave circuits 110A˜110D are configured to have, and perform data writing according to the broadcast write data BWD.

As illustrated in FIG. 2C, when the lower layer slave circuits 110A˜110D enter the broadcast mode, the upper layer master circuit 120 is configured to transmit a broadcast mode read command BRC that includes the broadcast address BAD to the lower layer slave circuits 110A˜110D, such that only one of the lower layer slave circuits 110A˜110D having one of the device addresses ADA˜ADD matching the broadcast address BAD performs data reading and returns an individual read data IRD.

More specifically, in the embodiment described above, since the broadcast address BAD is configured to be the device address ADA of lower layer slave circuit 110A, only the device address ADA of lower layer slave circuit 110A matches the broadcast address BAD. When the lower layer slave circuits 110A˜110D receive the broadcast mode read command BRC, only the lower layer slave circuit 110A performs data reading and returns the individual read data IRD.

In some approaches, when the lower layer slave circuits 110A˜110D operate in the broadcast mode, the upper layer master circuit 120 configures the lower layer slave circuits 110A˜110D to have the broadcast address BAD and simultaneously perform data reading and data writing on all the lower layer slave circuits 110A˜110D according to the broadcast address BAD.

Under such a condition, the lower layer slave circuits 110A˜110D only operate according to the broadcast address BAD instead of the device addresses ADA˜ADD thereof. However, once the upper layer master circuit 120 performs data reading on the lower layer slave circuits 110A˜110D, the lower layer slave circuits 110A˜110D simultaneously return data such that the upper layer master circuit 120 cannot perform data reading correctly.

In general, the lower layer slave circuits 110A˜110D that operate in the broadcast mode perform the same operation, which the same returned data is generated according to the data reading performed by the upper layer master circuit 120. As a result, after the upper layer master circuit 120 configures the lower layer slave circuits 110A˜110D to have the broadcast address BAD, the network apparatus 100 of the present invention requests only one of the lower layer slave circuits 110A˜110D that have one of the device addresses ADA˜ADD matching the broadcast address BAD returns data according to the broadcast mode read command BRC. By the configuration described above, the upper layer master circuit 120 can obtain the read data of the lower layer slave circuits 110A˜110D. The occurrence of the false data reading result due to the simultaneously data reading performed on the lower layer slave circuits 110A˜110D can be avoided.

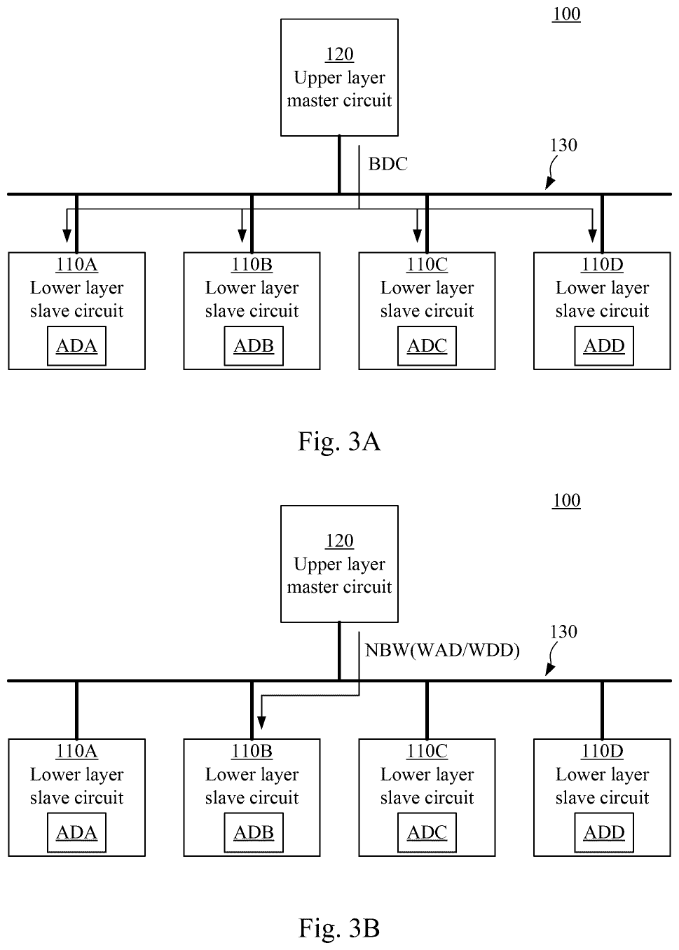

The operation of the lower layer slave circuits 110A˜110D in the non-broadcast mode is described in the following paragraphs in accompany with FIG. 3A to FIG. 3C.

FIG. 3A to FIG. 3C are block diagrams of the network apparatus 100 under the condition that the lower layer slave circuits 110A˜110D operate in the non-broadcast mode according to an embodiment of the present invention.

As illustrated in FIG. 3A, the upper layer master circuit 120 is configured to transmit a broadcast mode deactivation command BDC to the lower layer slave circuits 110A˜110D such that the lower layer slave circuits 110A˜110D remove the configuration of the broadcast address BAD and enter the non-broadcast mode.

In an embodiment, when the lower layer slave circuits 110A˜110D operate in the broadcast mode, the upper layer master circuit 120 controls the lower layer slave circuits 110A˜110D to enter the non-broadcast mode by transmitting the broadcast mode deactivation command BDC. However, when the lower layer slave circuits 110A˜110D already operate in the non-broadcast mode, the upper layer master circuit 120 does not need to transmit the broadcast mode deactivation command BDC.

As illustrated in FIG. 3B, when the lower layer slave circuits 110A˜110D operate in the non-broadcast mode, the upper layer master circuit 120 transmits a non-broadcast mode write command NBW that includes a write address WAD and write data WDD to the lower layer slave circuits 110A˜110D, such that one of the lower layer slave circuits 110A˜110D having one of the device addresses ADA˜ADD matching the write address WAD performs data writing according to the write data WDD. In FIG. 3B, the condition that the data writing is performed on lower layer slave circuit 110B is illustrated as an example.

As illustrated in FIG. 3C, when the lower layer slave circuits 110A˜110D operate in the non-broadcast mode, the upper layer master circuit 120 transmits a non-broadcast mode read command NBR that includes a read address RAD to the lower layer slave circuits 110A˜110D, such that one of the lower layer slave circuits 110A˜110D having one of the device addresses ADA˜ADD matching the read address RAD performs data reading and return read data RDD.

As a result, in the non-broadcast mode, the upper layer master circuit 120 performs data writing on one of the lower layer slave circuits 110A˜110D according to the write address WAD of the non-broadcast mode write command NBW and performs data reading on one of the lower layer slave circuits 110A˜110D according to the read address RAD of the non-broadcast mode read command NBR.

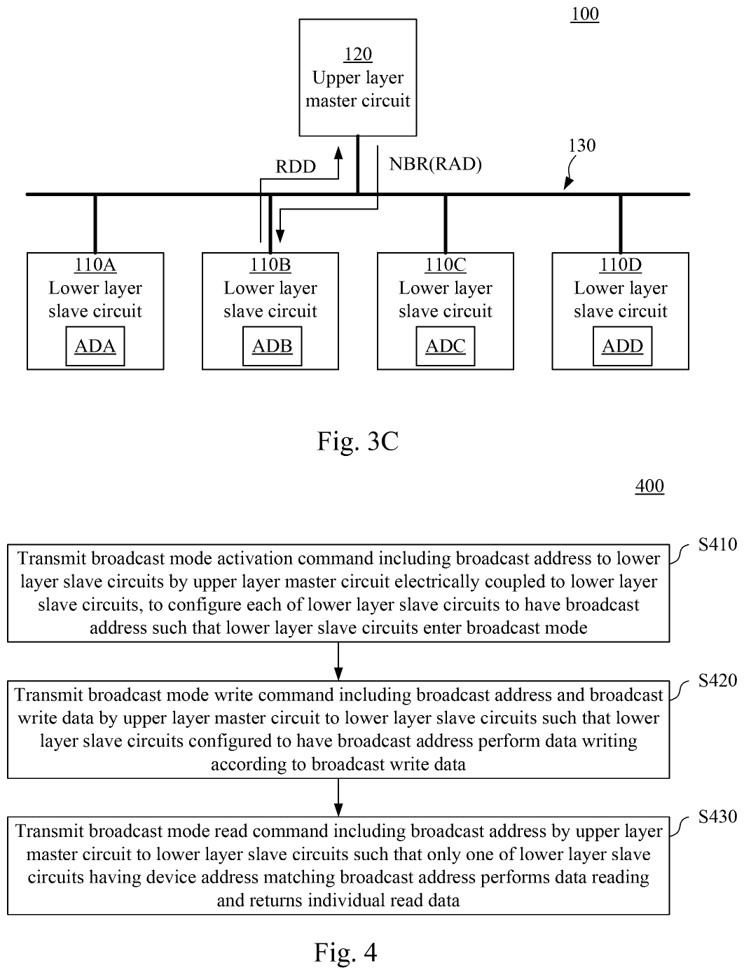

Reference is now made to FIG. 4. FIG. 4 illustrates a flow chart of a network apparatus operation method 400 having a slave circuit broadcast accessing mechanism according to an embodiment of the present invention.

In addition to the apparatus described above, the present disclosure further provides the network apparatus operation method 400 having the slave circuit broadcast accessing mechanism that can be used in such as, but not limited to, the network apparatus 100 in FIG. 1. As illustrated in FIG. 4, an embodiment of the network apparatus operation method 400 includes the following steps.

In step S410, the broadcast mode activation command BAC including the broadcast address BAD is transmitted to the lower layer slave circuits 110A˜110D by the upper layer master circuit 120 electrically coupled to the lower layer slave circuits 110A˜110D, to configure each of the lower layer slave circuits 110A˜110D to have the broadcast address BAD such that the lower layer slave circuits 110A˜110D enter the broadcast mode, wherein the lower layer slave circuits 110A˜110D each has one of the device addresses ADA˜ADD independent from each other.

In step S420, the broadcast mode write command BWC including the broadcast address BAD and the broadcast write data BWD is transmitted by the upper layer master circuit 120 to the lower layer slave circuits 110A˜110D such that the lower layer slave circuits 110A˜110D configured to have the broadcast address perform data writing according to the broadcast write data BWD.

In step S430, the broadcast mode read command BRC including the broadcast address BAD is transmitted by the upper layer master circuit 120 to the lower layer slave circuits 110A˜110D such that only one of the lower layer slave circuits 110A˜110D having one of the device addresses ADA˜ADD matching the broadcast address BAD performs data reading and returns individual read data IRD.

In practical implementation, the upper layer master circuit 120 is not required to perform the step S430 after the step S420. The order of the performance of the step S420 and the step S430 can be determined according to the practical requirements (i.e., the step S420 that performs data writing can be performed after the step S430 that performs data reading). Further, the upper layer master circuit 120 may perform the step S420 and the step S430 for a plurality of times according to the practical requirements. The present invention is not limited to a specific order of the performance of the steps and a specific number of times of the performance of the steps.

It is appreciated that the embodiments described above are merely an example. In other embodiments, it should be appreciated that many modifications and changes may be made by those of ordinary skill in the art without departing, from the spirit of the disclosure.

For example, the network apparatus described above includes 4 lower layer slave circuits. In other embodiments, the number of the lower layer slave circuits can be any number that is larger than 1 and within a reasonable range. The present invention is not limited to a specific number of the lower layer slave circuits.

In summary, the present invention discloses the network apparatus and the network apparatus operation method thereof having the slave circuit broadcast accessing mechanism to configure each of lower layer slave circuits to have a broadcast address and perform data writing on the lower layer slave circuits simultaneously according to a broadcast mode write command and requests only one of the lower layer slave circuits having the device address matching the broadcast address performing data reading according to a broadcast mode read command to avoid the false data reading result occurs due to the simultaneously reading.

The aforementioned descriptions represent merely the preferred embodiments of the present invention, without any intention to limit the scope of the present invention thereto. Various equivalent changes, alterations, or modifications based on the claims of present invention are all consequently viewed as being embraced by the scope of the present invention.

What is claimed is:

1. A network apparatus having a slave circuit broadcast accessing mechanism, comprising:
a plurality of lower layer slave circuits each having a device address independent from each other; and
an upper layer master circuit electrically coupled to the lower layer slave circuits to perform network communication through the lower layer slave circuits;
the upper layer master circuit configured to:
transmit a broadcast mode activation command comprising a broadcast address to the lower layer slave circuits to configure each of the lower layer slave circuits to have the broadcast address such that the lower layer slave circuits enter a broadcast mode;
transmit a broadcast mode write command comprising the broadcast address and broadcast write data to the lower layer slave circuits such that the lower layer slave circuits configured to have the broadcast address perform data writing according to the broadcast write data; and
transmit a broadcast mode read command comprising the broadcast address to the lower layer slave circuits such that only one of the lower layer slave circuits having the device address matching the broadcast address performs data reading and returns individual read data.

2. The network apparatus of claim 1, wherein the broadcast address is configured to be the device address of one of the lower layer slave circuits.

3. The network apparatus of claim 1, wherein the device address of each of the lower layer slave circuits is a sum of a base address and a device identification number.

4. The network apparatus of claim 1, wherein each of the lower layer slave circuits is a physical layer (PHY) circuit, and the upper layer master circuit is a media access control (MAC) circuit.

5. The network apparatus of claim 1, wherein the lower layer slave circuits and the upper layer master circuit perform communication through a serial management interface (SMI) such that each of the lower layer slave circuits serves as a serial management interface slave and the upper layer master circuit serves as a serial management interface master.

6. The network apparatus of claim 1, wherein the upper layer master circuit is further configured to transmit a broadcast mode deactivation command to the lower layer slave circuits such that the lower layer slave circuits remove the configuration of the broadcast address to enter a non-broadcast mode.

7. The network apparatus of claim 6, wherein when the lower layer slave circuits enter the non-broadcast mode, the upper layer master circuit is configured to:
transmit a non-broadcast mode write command comprising a write address and write data to the lower layer slave circuits such that one of the lower layer slave circuits having the device address matching the write address performs data writing according to the write data; and
transmit a non-broadcast mode read command comprising a read address to the lower layer slave circuits such that one of the lower layer slave circuits having the device address matching the read address performs data reading and returns read data.

8. A network apparatus operation method having a slave circuit broadcast accessing mechanism, comprising:
transmitting a broadcast mode activation command comprising a broadcast address to a plurality of lower layer slave circuits by an upper layer master circuit electrically coupled to the lower layer slave circuits, to configure each of the lower layer slave circuits to have the broadcast address such that the lower layer slave circuits enter a broadcast mode, wherein the lower layer slave circuits each has a device address independent from each other;
transmitting a broadcast mode write command comprising the broadcast address and broadcast write data by the upper layer master circuit to the lower layer slave circuits such that the lower layer slave circuits configured to have the broadcast address perform data writing according to the broadcast write data; and
transmitting a broadcast mode read command comprising the broadcast address by the upper layer master circuit to the lower layer slave circuits such that only one of the lower layer slave circuits having the device address matching the broadcast address performs data reading and returns individual read data.

9. The network apparatus operation method of claim 8, wherein the broadcast address is configured to be the device address of one of the lower layer slave circuits.

10. The network apparatus operation method of claim 8, wherein the device address of each of the lower layer slave circuits is a sum of a base address and a device identification number.

11. The network apparatus operation method of claim 8, wherein each of the lower layer slave circuits is a physical layer circuit, and the upper layer master circuit is a media access control circuit.

12. The network apparatus operation method of claim 8, the lower layer slave circuits and the upper layer master circuit perform communication through a serial management interface such that each of the lower layer slave circuits serves as a serial management interface slave and the upper layer master circuit serves as a serial management interface master.

13. The network apparatus operation method of claim 8, further comprising:
transmitting a broadcast mode deactivation command by the upper layer master circuit to the lower layer slave circuits such that the lower layer slave circuits remove the configuration of the broadcast address to enter a non-broadcast mode.

14. The network apparatus operation method of claim 13, further comprising:
transmitting a non-broadcast mode write command comprising a write address and write data by the upper layer master circuit to the lower layer slave circuits such that one of the lower layer slave circuits having the device address matching the write address performs data writing according to the write data when the lower layer slave circuits enter the non-broadcast mode; and
transmitting a non-broadcast mode read command comprising a read address by the upper layer master circuit to the lower layer slave circuits such that one of the lower layer slave circuits having the device address matching the read address performs data reading and returns read data when the lower layer slave circuits enter the non-broadcast mode.
